(19) United States
(12) Patent Application Publication
(10) Pub. No.: US 2021/0142428 A1
(43) Pub. Date: May 13, 2021

(54) PERFORMANCE DETERMINATION USING DYNAMIC LOCATION DATA

(71) Applicant: AllTheRooms, New York, NY (US)

(72) Inventors: Joseph DiTomaso, New York, NY (US); Lawson Taylor, New York, NY (US)

(21) Appl. No.: 16/774,568

(22) Filed: Jan. 28, 2020

Related U.S. Application Data
(60) Provisional application No. 62/934,010, filed on Nov. 12, 2019.

(51) Int. Cl. G06Q 50/12; G06Q 10/10; G06F 16/958; G06F 16/29

(52) U.S. Cl. CPC G06Q 50/12; G06Q 10/109; G06Q 30/0282; G06F 16/29; G06F 16/986

(57) ABSTRACT

Provided are a system and method for determining a value of a web listing based on content of the web listing and content of other web listings within a dynamic geographic area. The method may include receiving a network address of a listing of an object, extracting content from a website that corresponds to the network address and identifying an unavailability of the object from the extracted content, determining a value of the object based on the identified unavailability of the object and an unavailability of one or more other objects that are located within a predetermined geographic area of the object, and storing the determined value of the object within a storage device.

### CROSS-REFERENCE TO RELATED APPLICATION(S)

This application claims the benefit of U.S. Provisional Application No. 62/934,010, filed on Nov. 12, 2019, in the United States Patent and Trademark Office, and which is incorporated herein by reference for all purposes.

### BACKGROUND

Staying in a vacation home (rental) can be a great alternative to a hotel especially for individuals seeking more space, privacy, and comfort. Vacation rentals can also be more economical for larger groups of people travelling together as cost can be divided and shared among the group. Furthermore, vacation rentals also provide availability (e.g., small towns, neighborhoods, etc.) that typically do not offer hotels. Online travel-related marketplaces now provide listings of homes, rooms, and other rental opportunities available for booking. In some cases, these listings are provided side-by-side with listings for hotels.

However, one of the benefits of a hotel is that, from a consumers perspective, there is a reasonable expectation of quality given that many hotel chains provide similar service no matter the location. Meanwhile, ascertaining the quality and popularity of a rental home can be difficult. In many cases, the only insight a user can obtain is from posts/websites where other users have provided comments and/or feedback on their own personal experiences while staying at the vacation rental. This feedback, while it may be helpful, is still the result of subjective evaluations of other people. Furthermore, in some cases, vacation rental owners may forge their own “glowing” reviews in an effort to draw in more business.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a computing environment for determining performance of a web listing in accordance with an example embodiment.

FIG. 1B is a diagram illustrating a process of determining a performance value based on a comparison of web listing content in accordance with an example embodiment.

FIGS. 2A-2B are diagrams illustrating processes of dynamically selecting location data for performance determination in accordance with example embodiments.

FIG. 3 is a diagram illustrating a user interface displaying a performance value and performance improvement data in accordance with an example embodiment.

FIG. 4 is a diagram illustrating a method of determining a performance value based on dynamic location data in accordance with an example embodiment.

FIG. 5 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a platform which can determine a performance value for a web listings based on extracted web content including content within the web listing and content associated with the web listing. For example, the platform may receive a request to evaluate the performance of an object (e.g., a rental property, a personal property, etc.) that is included in a target web listing. In response, the platform may identify performance data from other web listings of other objects within a surrounding geographic area, and determine a performance value of the target web listing of the target object based on a comparison of the content of the target web listing and the content of the other web listings within the surrounding environment. According to various embodiments, the size of the surrounding environment that is used for the performance evaluation can be determined dynamically based on the geo-location of the object. The performance value may be transmitted or otherwise provided to an owner of the listing.

The host platform may extract web content on a regulator basis based on hypertext transfer protocol (HTTP) requests and responses. The host platform may store the extracted content within a database, storage, server, etc. By periodically, continuously, and repeatedly extracting content from various online host sites, the host platform can evaluate the listings from the sites over time and detect activity such as bookings, price fluctuations, and the like. For example, the host platform may query (e.g., HTTP query, etc.) an online calendar that is included within a web page of listing. The online calendar may store scheduling data of the object such as available, unavailable, or the like. The querying may provide the host platform with iCalendar data (i.e., RFC 5546 standard) indicating which days of the calendar are blocked off and considered a “booking” of the object.

Based on the extracted calendar data, the host platform may detect bookings by detecting changes in availability and unavailability. The host platform may include a group of servers (e.g., dozens of crawl servers, etc.) that capture calendar data, revenue data, and the like, of many different listings. The host platform may label the data with identifiers and store the data for future use. Additional data such as price data, revenue data of the listing/person/company retrieved from an additional web resource, and the like, may be used to create metrics associated with the web listings. In addition, the host platform may also extract similar content and revenue data associated with other web listings.

When the host platform receives a request to evaluate a listing, the host platform may retrieve content of the respective listing from the previously crawled and captured calendar and revenue data. Here, the web listing may be associated with a specific geographic location (e.g., GPS data, zip code, town, city, street address, etc.) According to various embodiments, the host platform may identify a dynamic geographic area associated with a geographic location of the web listing and extract crawled content of other listings in that same geographic area. Furthermore, the host platform may compare the bookings and revenue of these other listings in the same dynamically selected geographic area with the booking and revenue data of the requested web listing to generate a performance value of the requested web listing. The host platform may communicate this generated performance value via any desired communication channel (e.g., email, SMS, MMS, instant message, etc.) to a computing system associated with the requested web listing.

Bookings are used in various industries to reserve or schedule the use of a product, service, property, or the like, for a future date, for example, rental properties (vacation homes, villas, bed and breakfasts, cottages, etc.), medical services (spas, massages, chiropractor, doctor appointments, etc.), venue reservations (weddings, concerts, sporting events, graduations, ceremonies, etc.), entertainment, catering, transportation services, and many others. A merchant may use an online calendar (e.g., an iCalendar, etc.) in order to indicate that a booking has occurred and that the object is unavailable during a particular period of time (e.g., a day, a week, a month, etc.). As one example, when the merchant is a vacation rental owner, the owner may indicate that the vacation rental is unavailable to rent on various days using an online calendar. For example, the calendar may be queried with HTTP requests and provide content identifying availability and unavailability of the object.

Bookings are commonly used in the service industry and accommodations industry where search engines and other websites provide a listing of available services and rental properties (not just hotels) but places that have individual calendars for each room (e.g., vacation homes) which can be searched on a regular basis. However, other than user reviews which must be collected and read through, there is nothing that compares different objects in a related way thereby providing consumers with an understanding of the service, quality, and/or enjoyment they can expect. Therefore, a consumer is essentially in the dark. The example embodiments overcome this by providing a mechanism which determines performance values of listings from the content within the listings.

FIG. 1A illustrates a computing environment 100A for determining a performance of a web listing in accordance with an example embodiment. Referring to FIG. 1A, a host platform 120 may host a search website (e.g., a search engine, etc.), a comparison website, a mobile application, or the like. As another example, the host platform 120 may be unrelated with a search engine. The host platform 120 may receive web listings in the form of uniform resource locators (URLs) from hosts of the web listings during a registration process. The URLs may be stored in a queue 110 and processed in the order they are received. Here, the host platform 120 may grab one or more pending URLs from the queue 110 and identify web content and revenue data associated with the web listings.

For example, to register, a user may visit a website, mobile application, etc., and provide one or more property-listing URLs associated with a rental property (home, hotel, office, boat, plane, etc.) which are sent to the host platform 120 where it is queued for processing (e.g., within 12-24 hours) within the queue 110. In response, the host platform 120 may retrieve a list of pending URLs to be processed from the queue 110, and then collects content/data needed for the calculations by visiting the property-listing URLs. The system then performs aggregation of extracted data over a predetermined period of time (e.g., over the last couple of months, etc.), generates a performance value, and provides the performance value to the user/owner associated with the property listing

In the example of FIG. 1A, the host platform 120 reads a URL #1 from the queue 110 which is associated with an object such as a rental house, a boat, a plane, a consumer item, and the like. Here, the URL #1 directs the host platform 120 to a web page 130 with web content displayed therein. For example, the content within the web page 130 may include calendar data 132 displaying availability and unavailability of the object, user reviews 134, thumbnail images 136, pricing data 138, and the like.

A rental property/object may update its bookings on an associated website on a periodic or regular basis such as once a day or once every few hours. The host platform 120 may monitor these sites regularly and capture changes in content (calendar, price, etc.) and aggregate the data over time. As an example, the host platform 120 may visit a host server of the web page 130 through the Internet and detect calendar content and price content associated with an unavailability (also referred to as a booking) of the rental property. In one example embodiment, the host platform 120 may perform dozens of requests each second (e.g., 50 requests, 100 requests, or more) using many servers (e.g., 50 servers) to handle such requests at once. Accordingly, the host platform 120 may handle millions of requests on a daily basis (e.g., 4 million requests each day).

According to various embodiments, the host platform 120 may extract content from the web page 130 on a periodic basis. For example, the host platform 120 may extract calendar data 132 and price data 138 from the web page 130 for a period of one week, one month, two months, three months, and the like. In some embodiments, the host platform 120 may also store the web page 130 which has been previously crawled by the host platform 120 or another server not shown. Therefore, the host platform 120 may already have access to the last few weeks or months of data from the web page 130 including the calendar data 132 and the price data 138.

In some embodiments, the calendar content may be scraped from the calendar data 132 via an iCalendar protocol. For example, the host platform 120 may query a website via HTTP requests/responses using an iCalendar standard messaging protocol, or the like. Raw calendars may then be stored and subsequent retrieved from the cloud storage and parsed into raw tables in a data warehouse. The host platform 120 may perform a number of processing steps in order to derive information. For example, the host platform 120 may perform flattening of the calendar data to assess calendar differentials. Here, the “differential” is a change from available to not available which indicates a book or block. Furthermore, machine learning used to distinguish between booked and blocked periods.

As previously mentioned, the host platform 120 may perform a calendar differential process by comparing extracted calendar content of the calendar data 132 from two different points in time and identify a change in the content which corresponds to a period of unavailability. For example, a period of time may be available during a first querying, and may be unavailable during a second querying. The period of unavailability may be detected/labeled as a booking. The host platform 120 may store a table where each unavailability on a calendar has a corresponding entry in the table, etc. Furthermore, the host platform 120 can figure out specific days on the calendar that are booked, and a price for each of those days, and perform metrics for the listing. The metrics may be determined by comparing the days and prices of the property that have been booked with other properties in the same market area. Similarly, the host platform 120 can also scrape bookings and prices of other properties from other web listings 140 using the calendar differential.

For the calendar differential, the host server of the web page 130 may include an API which can be called through HTTP requests from the host platform 120 and which will send back all date information in the calendar data 132. As an example, the returned calendar information may have two states such as true or false. The resulting data may be a long string of days=true, true, true, false, false, etc.) where a value of “true” represents an available day and a value of “false” represents an unavailable day.

FIG. 1B illustrates a process 100B of determining a performance value based on a comparison of web listing content in accordance with an example embodiment. Referring to FIG. 1B, the host platform 120 queries web pages and retrieves content from the web page 130 associated with a target listing (URL #1). The host platform 120 also queries and retrieves content from one or more other web listings 140 which are directed towards property/objects within a same geographic area as the property/object associated with the web page 130. The geographic area may be determined as a “market area” that is relevant to the property/object in the target listing.

The geographic area (market area) that is used to identify other web listings, and retrieve content therefrom for comparison, may be dynamically determined by the host platform 120 based on a geographic location value of the listing 130 which may be obtained from its extracted content. For example, the geographic location value may be a zip code value, a street address value, latitude and longitude points associated with a property included in the listing, and the like.

As an example, if the host platform 120 is evaluating a target listing of a property within Hell's Kitchen New York, the system may dynamically define a market area around where the listing is located in Hell's Kitchen. The market area can be a polygon that is dynamically sized based on number of listings within that market area. For more densely populated areas such as Manhattan, N.Y., the market area may be a neighborhood of a couple of square blocks. However, for more sparsely populated areas such as small towns, small cities, etc., the market area may include the entire town, city, etc. The server may identify a geolocation of the listing based on a value within the extracted content, and then dynamically select/choose a polygon size for the market area based on the location.

The host platform 120 can take the listing (from web page 130) and all the other listings 140 in the market area, and process those to determine metrics such as avg daily rate, revenue per room, gross revenue, etc. Then, the host platform 120 may compare these metrics multiple times, smooths them, and generate an overall performance value 125 (e.g., a score) for the rental property or object associated with the listing on web page 130. The performance value 125 may be transmitted from the host platform 120 to a user device 150 associated with the web listing 130.

FIG. 3 illustrates an example of the performance score 125 being displayed via a user interface 300. In this example, the user interface 300 includes a geographic area 310 of the property/object being evaluated, a performance value 320 and a corresponding chart 322 indicating the overall possible score that can be achieved and where the current performance value 320 stands. The user interface 300 also includes an indicator 324 of a change in the performance value 320 since a last scoring/update, as well as a message 326 with an explanation of the performance value 320.

In some embodiments, the host platform 120 may also determine suggestions 330 of how to improve the performance score 320. For example, the host platform 120 may perform machine learning, etc. to identify various features that contribute to better performance values, and identify which of those features are not being performed based on the extracted web content from the target listing. The suggestions 330 may include text-based descriptions of ideas and insights into changing or modifying the service, the web listing, the prices, or the like.

The algorithm metrics of the market and the listings are mathematic functions. In some embodiments, the host platform 120 may smooth the metrics using a smoothing algorithm to smooth out data points. For example, if one listing does poorly most of the time, and then for one month does amazingly well, this metric may be smoothed.

To perform the metrics, the host platform 120 may go backward a predetermined amount of time (e.g., 2 weeks, 2 months, 4 months, etc.) The time window may be a sliding window that is based on listing data for a few months of time, or the like. If older data is considered (e.g., beyond the sliding time window), the smoothing out process may smooth out the data too much. Therefore, a sliding window may provide better accuracy.

Other embodiments include an instantaneous performance score. Applications for outputting the score may include buying a unit to vacation rental, determining the creditworthiness of the unit/object, and the like. As another example, a mortgage company could use it to evaluate whether it would lend money for the sale/purchase of the property/object. As another example, an insurance provider could sell insurance on only the days that the vacation rental is being rented. This could be an input on how to price the product.

FIGS. 2A-2B illustrate processes of dynamically selecting a location (market area) for performance determination in accordance with example embodiments. FIG. 2A illustrates a process 200A of selecting a geographical area 222 for a rental property that has a geographic location 224 on a map 220. Here, a host server 210 receives a value of the geographic location 224 from extracted web content associated with a listing of the rental property. In this example, the host server 210 that the geographic location 224 corresponds to a geographical area that is densely populated with other listings for rental properties. The host server 210 identifies a polygon (geographic area 222) which corresponds to a zip code+4 of the geographic location 224 as the market area for comparison. In this example, the geographic area 222 has 34 other web listings of rental properties for comparison.

Meanwhile, FIG. 2B illustrates a process 200B of selecting a geographical area 232 for a rental property that has a geographic location 234 on the map 220 shown in FIG. 2A. Here, the host server 210 receives a value of the geographic location 234 from extracted web content associated with a listing of a different rental property. In this example, the host server 210 detects that the geographic location 234 corresponds to a geographical area that is sparsely populated with web listings of other rental properties. Therefore, the host server 210 identifies a polygon 232 corresponding to a county which includes 5 zip codes as the market area for comparison. In this example, the geographic area 232 has 29 other web listings of rental properties for comparison.

Thus, the host platform of the example embodiments may dynamically determine a size of a polygon based on a geographic location of the rental property to be evaluated. The size of the polygon may be selected by the host platform based on the number of listings therein. For example, the host platform may attempt to find a predetermined number of listings (e.g., 30 listings) and find the size/shape of a geographic area that includes the property/object of the target web listing and that meets or is near the predetermined number of listings. Also, the polygon does not have to be a predefined zip code+4, zip code, town, county, city, etc., but may be any area that can be generated by the host platform. For example, the market area may be a few blocks, a portion of two zip codes but not all of the area encompassed by the two zip codes, etc.

The geographic value used to dynamically determine the market area may be a text value (string) that is read from the web content extracted from the target listing. As another example, the geographic value may be a latitude and longitude value associated with a website map of the listing, etc.

FIG. 4 illustrates a method 400 of determining a performance value based on dynamic location data in accordance with an example embodiment. As an example, the method 400 of FIG. 4 may be performed by a web server, a cloud platform, a database, a user device, and the like. Referring to FIG. 4, in 410, the method may include receiving a network address of a listing of an object. For example, the receiving may include receiving a request that is input via a user interface during a registration process of the web listing. As another example, the request may be automatically triggered by a host platform (e.g., periodically, etc.). Here, the network address may include a URL of a web listing of an object that is available for rent/reserve such as a property, a boat, a consumer item, and the like.

In 420, the method may include extracting content from a website that corresponds to the network address and identifying an unavailability of the object from the extracted content. To process the web listing, the host platform may store the web listing in a queue. A service, an application, a system, or the like, may periodically retrieve a batch of listings from the queue, extract content based thereon, and store the content within the host platform. The web content may include calendar content that is extracted from an online calendar which includes availability and unavailability data of the object. The content may be extracted through HTTP requests/responses based on the iCalendar standard.

In some embodiments, the method may further include storing the identified unavailability of the object within a data structure that includes a plurality of cells (e.g., such as a table, a two-dimensional data array, etc.) corresponding to a plurality of days over a predetermined period of time. In some embodiments, the storing may further include labeling cells corresponding to days of object unavailability with a first identifier, and labelling cells corresponding to days of object availability with a second identifier. In this example, the data structure may be updated such that only the days that have changed since a last check/extraction are updated. For example, the extracting may include updating previously extracted unavailability content stored in the storage device with newly extracted unavailability content.

In 430, the method may include determining a value of the object based on the identified unavailability of the object and an unavailability of one or more other objects that are located within a predetermined geographic area of the object. Here, the one or more other objects may be posted/listed and within a same geographical area as the web listing that is being evaluated. To determine the geographical area, the method may further include further dynamically determining a size of a polygon of the predetermined geographic area based on a geolocation of the object and mapping information stored at a server. For example, for a densely populated geographic area, the polygon may be a few square blocks, a neighborhood, a zip code+4, or the like. As another example, for a more sparsely populated geographic area the polygon may be an area of a town, an area of a city, an area of a county and the like. In these cases, the polygon may match the surrounding border of the geographical area (e.g., the zip code+4, the town, the city, the county, etc.).

In 440, the method may include storing the determined value of the object within a storage device. Furthermore, the determined value may be transmitted to a computing device that is associated with the web listing. For example, the host platform may transmit an email, an electronic message (SMS, MMS, etc.), or the like.

In some embodiments, the method may further include determining the unavailability of the one or more other objects based on web content extracted from listings of the one or more other objects within a sliding time window. In some embodiments, the method may further include smoothing the determined unavailability of the one or more objects to reduce anomalies prior to determining the value of the object.

FIG. 5 illustrates a computing system 500 that may be used in any of the methods and processes described herein, in accordance with an example embodiment. For example, the computing system 500 may be a database node, a server, a cloud platform, a user device, or the like. In some embodiments, the computing system 500 may be distributed across multiple computing devices such as multiple database nodes. Referring to FIG. 5, the computing system 500 includes a network interface 510, a processor 520, an input/output 530, and a storage device 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control the other components of the computing system 500.

The network interface 510 may transmit and receive data over a network such as the Internet, a private network, a public network, an enterprise network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage 540, or a combination thereof, may interact with applications executing on other devices.

The storage device 540 is not limited to a particular storage device and may include any known memory device such as RAM, ROM, hard disk, and the like, and may or may not be included within a database system, a cloud environment, a web server, or the like. The storage 540 may store software modules or other instructions which can be executed by the processor 520 to perform the method shown in FIG. 4. According to various embodiments, the storage 540 may include a data store having a plurality of tables, partitions and sub-partitions. Here, the data store may store parity data in columnar fashion. Therefore, the storage 540 may be used to store database objects, records, items, entries, and the like, associated with web listings.

As will be appreciated based on the foregoing specification, the above-described examples of the disclosure may be implemented using computer programming or engineering techniques including computer software, firmware, hardware or any combination or subset thereof Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or obj ect-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims

What is claimed is:

1. A computing system comprising:
a network interface configured to receive a network address of a listing of an object;
a processor configured to
extract content from a website that corresponds to the network address,
identify an unavailability of the object from the extracted content, and
determine a value of the object based on the identified unavailability of the object and an unavailability of one or more other objects that are located within a predetermined geographic area of the object; and
a storage configured to store the determined value of the object within a storage device.

2. The computing system of claim 1, wherein the processor is configured to dynamically determine a size of a polygon of the predetermined geographic area based on a geolocation of the object and mapping information stored at a server.

3. The computing system of claim 1, wherein the processor is further configured to store the identified unavailability of the object within a data structure comprising a plurality of cells corresponding to a plurality of days over a predetermined period of time.

4. The computing system of claim 3, wherein the processor is further configured to label cells corresponding to days of object unavailability with a first identifier, and label cells corresponding to days of object availability with a second identifier.

5. The computing system of claim 1, wherein the processor is further configured to queue the network address within a queue comprising network addresses of multiple listings.

6. The computing system of claim 1, wherein the processor is configured to update previously extracted unavailability content stored in the storage device with newly extracted unavailability content.

7. The computing system of claim 1, wherein the processor is further configured to determine the unavailability of the one or more other objects based on web content extracted from listings of the one or more other objects within a sliding time window.

8. The computing system of claim 7, wherein the processor is further configured to smooth the determined unavailability of the one or more objects to reduce anomalies prior to determining the value of the object.

9. A method comprising:
receiving a network address of a listing of an object;
extracting content from a website that corresponds to the network address and identifying an unavailability of the object from the extracted content;
determining a value of the object based on the identified unavailability of the object and an unavailability of one or more other objects that are located within a predetermined geographic area of the object; and
storing the determined value of the object within a storage device.

10. The method of claim 9, further comprising dynamically determining a size of a polygon of the predetermined geographic area based on a geolocation of the object and mapping information stored at a server.

11. The method of claim 9, further comprising storing the identified unavailability of the object within a data structure comprising a plurality of cells corresponding to a plurality of days over a predetermined period of time.

12. The method of claim 12, wherein the storing further comprises labeling cells corresponding to days of object unavailability with a first identifier, and labelling cells corresponding to days of object availability with a second identifier.

13. The method of claim 9, further comprising queuing the network address within a queue comprising network addresses of multiple listings.

14. The method of claim 9, wherein the extracting comprises updating previously extracted unavailability content stored in the storage device with newly extracted unavailability content.

15. The method of claim 9, further comprising determining the unavailability of the one or more other objects based on web content extracted from listings of the one or more other objects within a sliding time window.

16. The method of claim 15, further comprising smoothing the determined unavailability of the one or more objects to reduce anomalies prior to determining the value of the object.

17. A non-transitory computer-readable medium storing instructions which when executed by a processor cause a computer to perform a method comprising:
receiving a network address of a listing of an object;
extracting content from a website that corresponds to the network address and identifying an unavailability of the object from the extracted content;
determining a value of the object based on the identified unavailability of the object and an unavailability of one or more other objects that are located within a predetermined geographic area of the object; and
storing the determined value of the object within a storage device.

18. The non-transitory computer-readable medium of claim 17, wherein the method further comprises dynamically determining a size of a polygon of the predetermined geographic area based on a geolocation of the object and mapping information stored at a server.

19. The non-transitory computer-readable medium of claim 17, wherein the method further comprises storing the identified unavailability of the object within a data structure comprising a plurality of cells corresponding to a plurality of days over a predetermined period of time.

20. The non-transitory computer-readable medium of claim 17, wherein the method further comprises queuing the network address within a queue comprising network addresses of multiple listings.
